(19) United States
(12) Patent Application Publication
(10) Pub. No.: US 2026/0369506 A1
(43) Pub. Date: Nov. 19, 2026

(54) Current Limiting Receptacle

(71) Applicant: Dennis Gaggi, Newmarket (CA)

(72) Inventor: Dennis Gaggi, Newmarket (CA)

(21) Appl. No.: 19/209,292

(22) Filed: May 15, 2025

(51) Int. Cl. H01H 73/10; H01H 73/20

(52) U.S. Cl. CPC H01H 73/10; H01H 73/20; H01H 2231/00

(57) ABSTRACT

A current limiting receptacle providing localized overcurrent protection at the individual receptacle level is disclosed. The receptacle integrates a circuit breaker rated below standard branch circuit protection thresholds, typically at three, five, or eight amperes. The circuit breaker is electrically connected between the hot terminal and hot contact, while neutral and ground paths remain uninterrupted. During normal operation, current flows through the circuit breaker to any device plugged into the receptacle. When a connected device draws excessive current, the circuit breaker trips, isolating the fault without affecting other devices on the branch circuit. The receptacle includes optional load screws for extending protection to downstream devices. This innovation addresses the protection gap for loads drawing less than 15 amperes, particularly benefiting fractional horsepower motors and sensitive electronic equipment. The receptacle maintains standard duplex configuration and mounting methods while providing enhanced electrical protection within existing building infrastructure.

### CROSS-REFERENCE TO RELATED APPLICATIONS

There are no previously filed, nor currently any co-pending applications, anywhere in the world.

### BACKGROUND OF THE INVENTION

### 1. Field of the Invention

The present invention relates generally to the field of electrical receptacles and, more specifically, to a wall-mounted receptacles incorporating circuit breaker technology that provides localized protection for equipment drawing currents below standard branch circuit protection thresholds.

### 2. Description of the Related Art

In electrical distribution systems within buildings, branch circuit protection has traditionally been implemented at the panel level through circuit breakers or fuses, typically rated at 15 amperes or higher. This arrangement provides general overcurrent protection for entire circuits but presents significant limitations when addressing the specific needs of individual loads connected to receptacles along those circuits.

The existing standard for electrical protection creates a problematic gap wherein sensitive electronic equipment, small appliances, and particularly fractional horsepower motors remain vulnerable to damaging electrical conditions despite the presence of branch circuit protection. A device drawing 10 amperes, for instance, could experience damaging overcurrent conditions without triggering the 15-ampere branch protection, resulting in equipment failure or presenting potential fire hazards.

When a fault occurs at a single receptacle in a conventional system, the entire branch circuit typically loses power when the main breaker trips. This creates unnecessary disruption to other functioning devices on the same circuit and complicates troubleshooting efforts, as maintenance personnel must determine which of potentially numerous outlets caused the protection to activate.

Extension cords with integrated circuit protection exist in the prior art, but these represent temporary, portable solutions requiring additional components rather than addressing the fundamental protection gap at the fixed receptacle level. Similarly, replaceable fused plugs provide only non-resettable protection within cord systems rather than permanent building infrastructure.

Ground fault circuit interrupter (GFCI) technology addresses different safety concerns by monitoring differential current between hot and neutral conductors to protect against shock hazards but does not address simple overcurrent conditions that damage equipment without presenting shock risks.

Facilities with sensitive equipment, particularly those operating fractional horsepower motors which are highly susceptible to damage from sustained minor overcurrent conditions, have lacked suitable protection options at the individual receptacle level. This protection gap has historically resulted in premature equipment failure, increased maintenance costs, and elevated fire risk from equipment operating in sustained overcurrent conditions that fall below branch circuit protection thresholds.

The need exists for an electrical receptacle that provides localized, resettable overcurrent protection rated below standard branch circuit thresholds, capable of being permanently installed within building electrical systems while maintaining code compliance and offering protection without requiring additional components such as specialized cords or plugs.

### SUMMARY OF THE INVENTION

It is thus an object of the present invention to provide a current limiting receptacle that incorporates a circuit breaker rated below standard branch circuit protection thresholds, thereby protecting sensitive equipment and fractional horsepower motors from damaging overcurrent conditions while isolating electrical faults at the individual receptacle level without affecting other devices on the same circuit.

It is a feature of the present invention to provide the integration of a sub-15 A overcurrent protection directly at an individual wall receptacle level.

The present invention provides a Current Limiting Receptacle (CLR) specifically designed to provide localized overcurrent protection at the individual wall receptacle level. This device integrates a circuit breaker directly into the electrical receptacle assembly, creating a protection mechanism that can isolate electrical faults without affecting other components on the same branch circuit.

The fundamental innovation of the CLR lies in addressing a significant protection gap in electrical systems: the lack of protection for loads under 15 A at the individual receptacle level. The implementation features circuit breaker ratings of 3 A, 5 A, or 8 A, which are specifically calibrated to protect fractional horsepower motors and other sensitive equipment that traditional branch circuit protection (typically 15 A or 20 A) cannot adequately safeguard.

The device maintains a standard duplex configuration with two hot slots, two neutral slots, and two ground slots. Connection is made through hot, neutral, and ground screws that are color-coded according to electrical standards (brass, silver, and green, respectively). These connect to the hot terminal, neutral terminal, and ground yoke. The ground yoke serves as the main mechanical connection point to the receptacle box through mounting screws.

The circuit breaker is centrally located on the receptacle and is designed to trip at a lower threshold than the branch circuit overcurrent protective device. This prevents “race conditions” during overload or short circuit events. The hot line connects through the circuit breaker before reaching the hot contact, creating a protected circuit path. The neutral line connects directly to the neutral contact, maintaining code compliance with unbroken neutral/ground paths.

It is an advantage of the present invention to provide localized overcurrent protection directly at the receptacle level, eliminating the protection gap for loads drawing less than 15 amperes.

It is another advantage of the present invention to isolate electrical faults at the individual receptacle level, preventing a single problematic device from affecting other components connected to the same branch circuit.

It is an advantage of the present invention to offer specific protection for fractional horsepower motors and sensitive electronic equipment that are particularly vulnerable to damage from sustained minor overcurrent conditions.

It is another advantage of the present invention to maintain code compliance by implementing overcurrent protection only on the line conductor while preserving unbroken neutral and ground paths.

It is an advantage of the present invention to simplify troubleshooting processes by providing clear, visible indication of exactly which receptacle experienced an overcurrent condition.

It is another advantage of the present invention to reduce fire hazards associated with equipment operating in sustained overcurrent conditions that fall below branch circuit protection thresholds.

It is an advantage of the present invention to provide an extra layer of defense against electrical surges and spikes that might damage connected equipment without tripping branch circuit protection.

It is another advantage of the present invention to offer resettable protection through an integrated circuit breaker, eliminating the need to replace fuses or other components after an overcurrent event.

It is an advantage of the present invention to extend protection to downstream conventional receptacles through optional load screws, maximizing protection coverage while minimizing installation costs.

It is another advantage of the present invention to enhance electrical safety through permanent, building infrastructure-level protection rather than relying on temporary or portable protection solutions.

Further features of the invention will become apparent in the course of the following description.

### BRIEF DESCRIPTION OF DRAWINGS

The advantages and features of the present invention will become better understood with reference to the following more detailed description and claims taken in conjunction with the accompanying drawings, in which like elements are identified with like symbols, and in which:

FIG. 1 is a front elevation view of a current limiting receptacle 10, in accordance with a preferred embodiment of the present invention;

FIG. 2 is a side elevation view of a hot contact 115 of the current limiting receptacle 10, in accordance with a preferred embodiment of the present invention;

FIG. 3 is a side elevation view of a hot terminal 50 of the current limiting receptacle 10, in accordance with a preferred embodiment of the present invention;

FIG. 4 is a side elevation view of a neutral terminal 55 of the current limiting receptacle 10, in accordance with a preferred embodiment of the present invention;

FIG. 5 is a side elevation view of a neutral contact 120 of the current limiting receptacle 10, in accordance with a preferred embodiment of the present invention;

FIG. 6 is a side elevation view of a ground yoke 65 of the current limiting receptacle 10, in accordance with a preferred embodiment of the present invention; and,

FIG. 7 is an electrical schematic view of the current limiting receptacle 10, in accordance with a preferred embodiment of the present invention.

### DETAILED DESCRIPTION OF THE INVENTION

The best mode for carrying out the invention is presented in terms of its preferred embodiment, herein depicted within the Figures. It should be understood that the legal scope of the description is defined by the words of the claims set forth at the end of this patent and that the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

The best mode for carrying out the invention is presented in terms of its preferred embodiment, herein depicted within the Figures.

### 1. Detailed Description of the Figures

Referring now to the drawings, wherein like reference numerals 5 indicate the same parts throughout the several views, a current limiting receptacle, generally noted as 10, is provided according to a preferred embodiment of the present invention. The current limiting receptacle 10 provides localized overcurrent protection to induce a fault in a device connected thereto to trip a circuit breaker 80 directly at the current limiting receptacle 10, thereby isolating the problem without affecting any remaining components of the branch. This reduces the risk of widespread power outages, minimizes potential fire hazards, simplifies troubleshooting, provides an extra layer of defense against surges and spikes, provides for more control over power distribution.

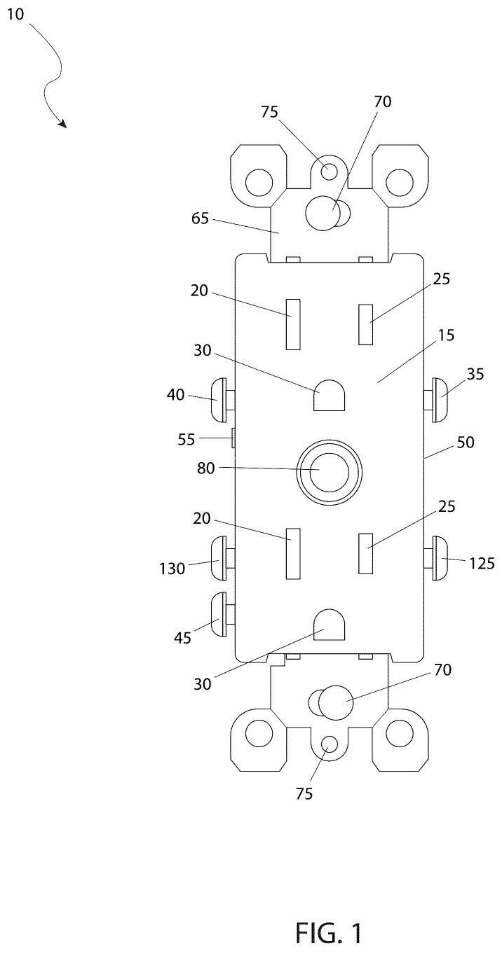

Referring to FIG. 1, a front elevation view of the current limiting receptacle 10, it can be seen that in an exemplary view, a front face 15, made of a non-conductive material such as plastic, is provided. In a duplex configuration as shown, the current limiting receptacle 10 is provided with two (2) neutral slots 20, two (2) hot slots 25, and two (2) ground slots 30. Connection to the current limiting receptacle 10 is made in a customary manner with the use of a hot line screw 35, a neutral line screw 40, and a ground screw 45. The hot line screw 35 is envisioned to be brass in color, the neutral line screw 40 is envisioned to be silver in color, and the ground screw 45 is envisioned to be green in color. The hot line screw 35, the neutral line screw 40, and the ground screw 45 are in electrical communication with a hot terminal 50 (as can be seen in FIG. 3), a neutral terminal 55 (as can be seen in FIG. 4), and a ground yoke 65 (as can be seen in FIG. 6), respectively. The ground yoke 65 is provided to serve as a main mechanical connection point via two (2) mounting screws 70 which connect it to a receptacle box in a customary manner. Two (2) threaded tabs 75 allow for the mechanical connection of a receptacle cover plate in a customary manner.

A circuit breaker 80 is centrally located on the current limiting receptacle 10. The rating of the circuit breaker 80 is envisioned to be three, five, or eight amperes (3 A, 5 A, or 8 A) depending on the application. In all cases, it would be less than the overcurrent protective device on the branch circuit in order to avoid a “race” condition in the event of an overload or short circuit event. The exact rating of the circuit breaker 80 is not intended to be a limiting factor of the present invention. A hot load screw 125 and a neutral load screw 130 may be provided to afford downstream devices, such as at least one (1) conventional receptacle and an overcurrent protection as provided by the circuit breaker 80. In such a manner, overcurrent protection can be afforded without the use of multiple current limiting receptacles 10 and any associated cost.

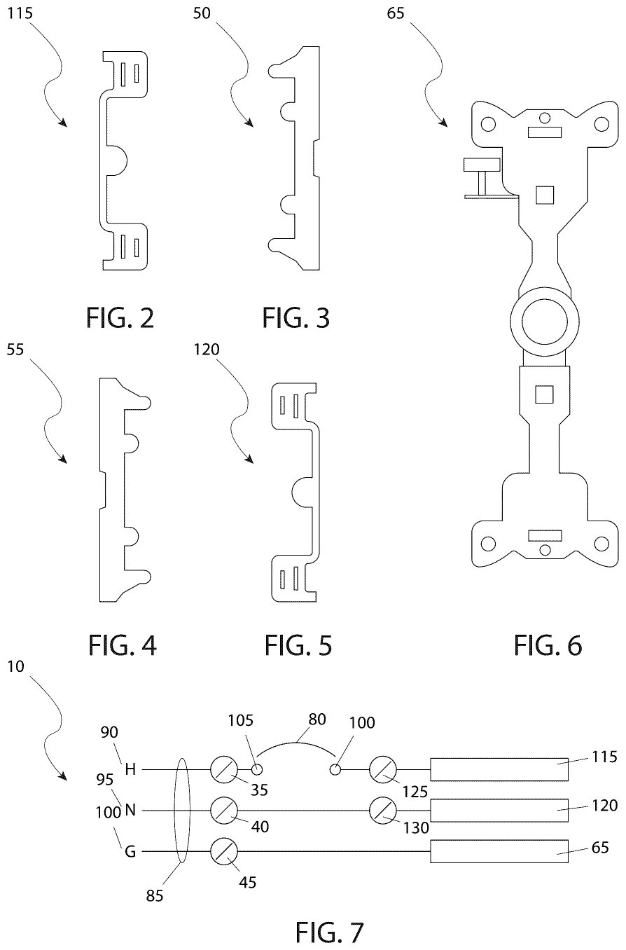

Referring now more closely to FIG. 7, an electrical schematic view of the current limiting receptacle 10, further description is provided. The branch circuit wiring 85, including the hot conductor 90, the neutral conductor 95, and the ground conductor 100 is electrically connected to the hot line screw 35, the neutral line screw 40, and the ground screw 45, respectively. The hot line screw 35, in conjunction with the hot terminal 50, is connected to the input connection 105 of the circuit breaker 80, while the output connection 110 is connected to the hot contact 115 (as shown in FIG. 2). The hot contact 115 is mechanically accessible via the hot slot 25 (as shown in FIG. 1). The neutral line screw 40, in conjunction with the neutral terminal 55, is in direct electrical contact with a neutral contact 120 (as seen in FIG. 5). The neutral contact 120 is mechanically accessible via the neutral sot 20 (as shown in FIG. 1). Similarly, the ground screw 45, in conjunction with the ground yoke 65, is mechanically accessible via the ground slot 30 (as shown in FIG. 1). In such a manner, current being utilized by the current limiting receptacle 10 must pass through the circuit breaker 80, where it is limited. The hot load screw 125 is provided on the load side of the circuit breaker 80 to allow for connection of downstream wiring. The neutral load screw 130 is provided at the same electrical potential as the neutral line screw 40 to allow for ease of any physical downstream wiring connection.

The teachings of the current limiting receptacle 10 may be adapted to a wide variety of electrical receptacles beyond the NEMA 5-15 as shown in FIG. 1). Additionally, other styles of receptacles beyond the Leviton© style (as shown in FIG. 1), may also be utilized. As such, the present invention shall not be limited by type, ratings, styles, voltage levels, current ratings, colors, wiring connection methods (screws, stabs, WAGO© connectors, and the like) shall not be a limiting factor of the present invention.

### 2. Operation of the Preferred Embodiment

The operation of the current limiting receptacle 10 occurs seamlessly within an electrical system. When installed in a standard receptacle box and connected to branch circuit wiring 85, the device functions like a conventional duplex receptacle while providing enhanced protection. During normal operation, current flows from the hot conductor 90 through the hot line screw 35 to the hot terminal 50, then through the circuit breaker 80 to the hot contact 115, making electrical connection with any device plugged into the hot slot 25. The neutral path remains uninterrupted, flowing directly from the neutral conductor 95 through the neutral line screw 40 to the neutral terminal 55 and the neutral contact 120. When a connected device draws current exceeding the rating of the circuit breaker 80 (3 A, 5 A, or 8 A depending on configuration), the circuit breaker 80 trips, interrupting power to that specific receptacle while maintaining power to all other devices on the branch circuit. The user can then investigate the cause of the overcurrent condition, remove or repair the problematic device, and reset the circuit breaker 80 by pressing its reset button. This localized protection is particularly valuable for fractional horsepower motors and sensitive electronic equipment that could sustain damage from overcurrent conditions below the threshold of standard branch circuit protection.

The foregoing descriptions of specific embodiments of the present invention are presented for purposes of illustration and description. The Title, Background, Summary, Brief Description of the Drawings and Abstract of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples and the various features are grouped together in various embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the Detailed Description, with each claim standing on its own as a separately claimed subject matter.

The claims are not intended to be limited to the aspects described herein but is to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way. Any unintended embracement of such subject matter is hereby disclaimed. They are not intended to be exhaustive nor to limit the invention to precise forms disclosed and, obviously, many modifications and variations are possible in light of the above teaching. The embodiments are chosen and described in order to best explain principles of the invention and its practical application, to thereby enable others skilled in the art to best utilize the invention and its various embodiments with various modifications as are suited to the particular use contemplated. It is intended that a scope of the invention be defined broadly by the Drawings and Specification appended hereto and to their equivalents. Therefore, the scope of the invention is in no way to be limited only by any adverse inference under the rulings of Warner-Jenkinson Company, v. Hilton Davis Chemical, 520 US 17 (1997) or Festo Corp. v. Shoketsu Kinzoku Kogyo Kabushiki Co., 535 U.S. 722 (2002), or other similar caselaw or subsequent precedent should not be made if any future claims are added or amended subsequent to this Patent Application.

1. A current limiting receptacle comprising:
a front face having at least one hot slot, at least one neutral slot, and at least one ground slot;
a hot terminal connected to a hot line screw;
a neutral terminal connected to a neutral line screw;
a ground yoke connected to a ground screw;
a circuit breaker having an input connection and an output connection, wherein the input connection is electrically connected to the hot terminal, and wherein the circuit breaker is rated at less than fifteen amperes;
a hot contact electrically connected to the output connection of the circuit breaker and mechanically accessible via the at least one hot slot;
a neutral contact electrically connected to the neutral terminal and mechanically accessible via the at least one neutral slot; and
wherein the ground yoke is mechanically accessible via the at least one ground slot.

2. The current limiting receptacle of claim 1, wherein the circuit breaker is rated at three amperes, five amperes, or eight amperes.

3. The current limiting receptacle of claim 1, further comprising a hot load screw electrically connected to the output connection of the circuit breaker.

4. The current limiting receptacle of claim 3, further comprising a neutral load screw electrically connected to the neutral terminal.

5. The current limiting receptacle of claim 1, wherein the ground yoke serves as a main mechanical connection point for mounting the current limiting receptacle to a receptacle box.

6. The current limiting receptacle of claim 1, wherein the front face has a duplex configuration comprising two hot slots, two neutral slots, and two ground slots.

7. A current limiting electrical receptacle system comprising:
a duplex configuration receptacle having a non-conductive front face;
at least one hot slot, at least one neutral slot, and at least one ground slot disposed in the front face;
a hot terminal electrically connected to a hot line screw for receiving a hot conductor of a branch circuit;
a neutral terminal electrically connected to a neutral line screw for receiving a neutral conductor of the branch circuit;
a ground yoke electrically connected to a ground screw for receiving a ground conductor of the branch circuit;
a circuit breaker having an input connection and an output connection, wherein the input connection is electrically connected to the hot terminal, wherein the circuit breaker is rated lower than a branch circuit overcurrent protective device;
a hot contact electrically connected to the output connection of the circuit breaker and accessible through the at least one hot slot; and
a neutral contact electrically connected to the neutral terminal and accessible through the at least one neutral slot.

8. The current limiting electrical receptacle system of claim 7, wherein the circuit breaker is configured to provide protection for fractional horsepower motors.

9. The current limiting electrical receptacle system of claim 7, further comprising load screws for connecting downstream devices to the current limiting electrical receptacle system.

10. The current limiting electrical receptacle system of claim 7, wherein the circuit breaker is rated at less than fifteen amperes.

11. A receptacle-level overcurrent protection system comprising:
a standard form factor electrical receptacle having a front face with slots for receiving electrical prongs;
a hot terminal for connection to a branch circuit hot conductor;
a neutral terminal for connection to a branch circuit neutral conductor;
a ground terminal for connection to a branch circuit ground conductor;
a circuit breaker rated below fifteen amperes installed within the electrical receptacle; and
wherein the circuit breaker is electrically connected between the hot terminal and a hot contact accessible through a hot slot in the front face, providing overcurrent protection at the individual receptacle level while maintaining unbroken neutral and ground paths.

12. The receptacle-level overcurrent protection system of claim 11, wherein the circuit breaker is specifically configured to provide protection for fractional horsepower motors and sensitive electronic equipment.
